(19) United States
(12) Patent Application Publication
(10) Pub. No.: US 2025/0283368 A1
(43) Pub. Date: Sep. 11, 2025

(54) Universal Garage Door Smart Controller

(71) Applicant: Thomas Paul Pomian, Alpharetta, GA (US)

(72) Inventor: Thomas Paul Pomian, Alpharetta, GA (US)

(21) Appl. No.: 19/001,333

(22) Filed: Dec. 24, 2024

Related U.S. Application Data
(60) Provisional application No. 63/614,623, filed on Dec. 24, 2023.

(51) Int. Cl. E05F 15/77; E05F 15/73; E05F 15/75

(52) U.S. Cl. CPC E05F 15/77; E05F 15/75; E05F 2015/767; E05Y 2900/106

(57) ABSTRACT

In some implementations, the controller may include capturing, via a camera in the garage and the use of Artificial Intelligence (AI), an image of an interior of the garage upon a delivery associate causing movement of the garage door as part of positioning of the object in the garage by the delivery associate. In addition, the controller may include detecting, based on the image, a position of the object relative to a delivery location in the garage. The controller may include determining the delivery of the object is unsuccessful in response to detecting the position of the object outside of the delivery location. Moreover, the controller may include limiting opening of the garage door in response to determining the delivery is unsuccessful.

### CROSS-REFERENCE TO RELATED APPLICATION

This patent application claims priority to U.S. Provisional Patent Application No. 63/614,623, filed on Dec. 24, 2023, and entitled “System and Method for Universal Package Delivery using a Garage Door Opener.” The disclosure of the prior application is considered part of and is incorporated by reference into this patent application.

### BACKGROUND

More than ever, consumers are desiring a safer, simpler way to secure and monitor their garages. This invention allows people to see the status of the space inside their garage and alert them if there is an urgent issue they need to attend to, such as a fire, toxic levels of Carbon Monoxide (CO), intruder, maintenance cadence, or package delivery.

Consumers are receiving goods via delivered packages at the highest levels and it continues to rise. Online shopping, via online vendors such as Amazon, FedEx, UPS, DHL and other business-to-consumer companies, has increased the volume of package deliveries to consumers.

One problem associated with package delivery is how to ensure that the packages are securely delivered. As the rate of package delivery has risen, so has the rate at which packages are stolen by thieves. However, existing methods of securely delivering packages have various drawbacks.

For example, in some cases, the package sender may require the delivery company to deliver the package to the consumer in person and obtain a signature from the consumer confirming the delivery. As consumers know, this arrangement can be very inconvenient, as it either requires them to be physically present at the delivery location when the delivery is made or requires them to travel to a package facility to pick up their package in person.

As one attempt at securing packages, Amazon has created secure package drop-off and delivery locations for their customers. These “lockers” are secure package drop-off and delivery sites, much like postage boxes that can be found inside U.S. Postal Service locations. As with U.S. Postal Service locations, however, for a consumer to use one of these lockers, they must either travel to the locker to deposit their package (such as for a product return) or travel to the locker to pick up their package. This can be inconvenient and, particularly for the elderly and those with disabilities and the like, not an option. An improved method and system for securing the delivery of packages is desired.

### SUMMARY

It is to be understood that both the following general description and the following detailed description are exemplary and explanatory only and are not restrictive. The present disclosure relates to an improvement to the garage delivery system of the type discussed above, and to the security of garage delivery systems. One or more goals may be realized in the delivery system claimed in the present disclosure. According to the instructions in the introduction, a garage delivery system is provided.

In one general aspect, an underroof and in garage, garage door opening controller having a high definition (HD) camera for monitoring in-garage status of deliveries and other conditions is provided. A button is provided for actuating a garage door, the garage door opening controller connectable to a wireless access point, wherein the wireless access point is connected to sensors, such as a carbon monoxide sensor, smoke detector, temperature sensor, and humidity sensor. A carrier platform is provided also to allow delivery of parcels to the garage.

Based on a threshold reading from the sensors, the sensors can send a command to the controller to open the garage door a small distance so that the garage can be ventilated, to allow the threshold readings to be returned to acceptable levels and an alert is also sent to a mobile app monitoring the status of an interior of the garage. A system and method for accomplishing the same is also provided by the invention.

These and other features, aspects and advantages of various embodiments will become better understood with reference to the following description and appended claims. The accompanying drawings, which are incorporated in and constitute a part of this specification, illustrate embodiments of the present disclosure and, together with the description, explain the related principles.

### BRIEF DESCRIPTION OF THE DRAWINGS

The present disclosure will be better understood using the description and accompanying drawings, which illustrate several non-limiting aspects by way of example.

FIG. 1 is a profile view of the garage door opening controller according to the present invention;

FIG. 2 illustrates the carrier platform according to the present invention;

FIG. 3 illustrates a flow diagram of the carrier delivery system according to the invention;

FIG. 4 illustrates the mounting location of the garage door opening system according to the invention.

Based on the description and figures, those skilled in the art will be able to deduce other advantageous characteristics of the garage delivery system. Aspects and advantages of embodiments of the present disclosure will be set forth in part in the following description, or may be learned from the description, or may be learned through practice of the embodiments.

### DETAILED DESCRIPTION

Reference now will be made in detail to embodiments, one or more examples of which are illustrated in the drawings. Each example is provided by way of explanation of the embodiments, not limitation of the embodiments. In fact, it will be apparent to those skilled in the art that various modifications and variations can be made in the present disclosure without departing from the scope or spirit of the invention. For instance, features illustrated or described as part of one embodiment can be used with another embodiment to yield a still yet further embodiment. Thus, it is intended that the present disclosure covers such modifications and variations as come within the scope of the appended claims and their equivalents.

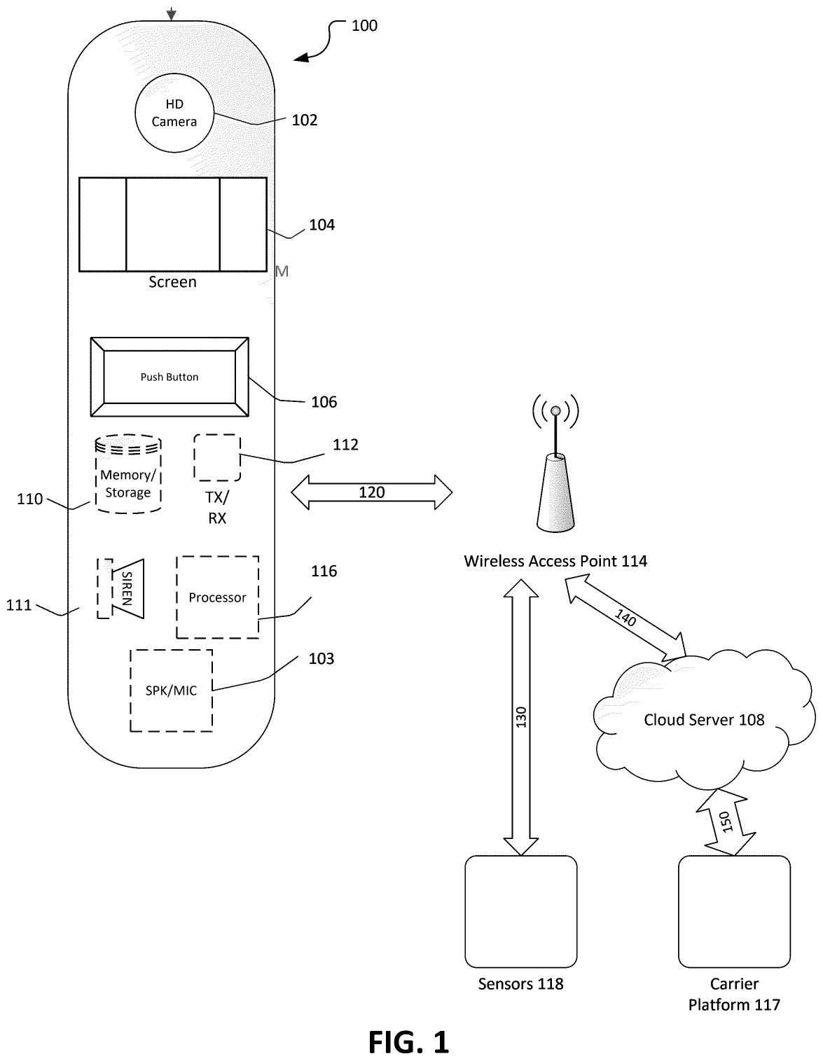

As used in the specification and the appended claims, the singular forms “a,” “an,” and “the” include plural referents unless the context clearly dictates otherwise. In reference to FIG. 1, the universal garage door controller 100 comprises an HD camera 102. The camera 102, or high-definition camera, may be a camera capable of shooting 1080P and up to 30 FPS (frames per second). The HD camera 102 may also be designed to shoot night vision, to display a clear view day/night. The HD camera 102 is a type of digital camera that captures video and images at a higher resolution than standard-definition cameras. HD cameras typically offer resolutions of 720p, 1080p, or higher, providing clearer and more detailed images. The increased resolution allows for better image quality. These cameras often come equipped with advanced features like autofocus, image stabilization, and enhanced low-light performance, which further contribute to the clarity and quality of the captured media.

The universal garage door controller 100 may also be designed with a HD Screen 104, to display a clear view open or closed status of your garage door by showing live video from the inside of your garage towards your garage door in the mobile app (not shown). The HD Screen 104 can be an LCD screen and the term “HD” typically stands for “High Definition,” which refers to a resolution standard for video and display technology. High Definition is characterized by a higher resolution and quality compared to standard definition (SD), providing clearer, more detailed images and a more immersive viewing experience. HD resolutions generally start at 720p (1280×720 pixels) and can go up to 1080p (1920×1080 pixels), with the “p” standing for progressive scan, which means each frame of video is drawn sequentially. This contrasts with interlaced video, where each frame is drawn in alternating lines. HD technology is widely used in various applications, including television broadcasts, streaming services, video games, and digital cameras, offering enhanced visual clarity and detail. The universal garage door controller 100 can also be equipped with a push button 106, used to actuate the opening of the garage door through wired connection or a wireless connection.

The universal garage door controller 100 may also have a memory/storage device 110 for storing videos, settings, and the like. The memory/storage 110 device is an electronic component or system used to store digital data, allowing computers and other electronic devices to retain information for immediate or future use. The memory/storage 110 device can be categorized into two main types: volatile and non-volatile memory. Volatile memory, such as Random Access Memory (RAM), requires power to maintain the stored information and is typically used for temporary data storage that the CPU needs to access quickly. Non-volatile memory, on the other hand, retains data even when the power is turned off, making it suitable for long-term data storage. Examples of non-volatile memory include solid-state drives (SSDs), hard disk drives (HDDs), and flash drives.

Memory/storage devices 110 are critical components in computing systems, influencing both the performance and capacity of these systems. They vary widely in terms of speed, capacity, form factor, and cost, allowing them to be tailored to specific applications and user needs. For instance, SSDs are known for their high speed and durability, making them ideal for applications requiring fast data access, while HDDs offer larger storage capacities at a lower cost, suitable for bulk data storage. Additionally, advancements in technology continue to enhance the capabilities of memory/storage devices, leading to increased storage densities, faster data transfer rates, and reduced physical sizes, thus enabling more efficient and powerful computing solutions.

The universal garage door controller 100 may also include processor 116. Processor 116, often referred to as a central processing unit (CPU), is the primary component of a computer that performs most of the processing inside a computer. It executes instructions from programs through a sequence of basic operations such as arithmetic, logic, control, and input/output (I/O) operations specified by the instructions. The processor 116 interprets and processes data from the computer's memory, enabling the execution of complex tasks by breaking them down into simpler operations. It is essentially the brain of the computer, coordinating the activities of all other hardware components and ensuring that tasks are completed efficiently and accurately.

Modern processors are composed of multiple cores, which allow them to perform parallel processing, significantly increasing their computational power and efficiency. This multi-core architecture enables the simultaneous execution of multiple tasks, enhancing the overall performance of the system. Additionally, processor 116 can also include integrated features such as cache memory, which provides faster data access, and specialized instruction sets that optimize performance for specific tasks, such as graphics processing or machine learning. The processor 116 may also have on device Artificial Intelligence (AI) also, which can assist the controller in determining that a parcel has been delivered. The design and capabilities of a processor are critical determinants of a computer's performance, influencing how quickly and effectively it can run applications and process data.

The universal garage door controller 100 may also include a transmitter/receiver 112, often referred to as a transceiver, a transmitter/receiver 112 is an electronic device or component that combines transceiver 112 to send and receive signals, making it an integral part of the communication system. In the context of wireless communication, a transmitter/receiver 112 converts electrical signals into radio waves for transmission and vice versa for reception. This process involves modulation and demodulation, where the transmitter 112 encodes information onto a carrier wave, and the receiver decodes the information back into its original form. A transceiver is commonly used in various applications, including radio communication, telecommunications, and networking, enabling efficient and seamless data exchange over different distances and media.

Transmitter/receivers are designed to operate across a range of frequencies and can be found in numerous devices, from simple walkie-talkies to complex satellite communication systems. They are essential in both analog and digital communication, supporting various protocols and standards to ensure compatibility and interoperability between different systems. The integration of transmitter and receiver functions into a single unit not only reduces the size and cost of communication devices but also enhances their performance by allowing more sophisticated signal processing and error correction techniques. As technology advances, transmitter/receivers continue to evolve, incorporating features like multiple-input multiple-output device (MIMO) technology and software-defined radio (SDR) capabilities to improve bandwidth efficiency, signal quality, and adaptability to changing communication environments.

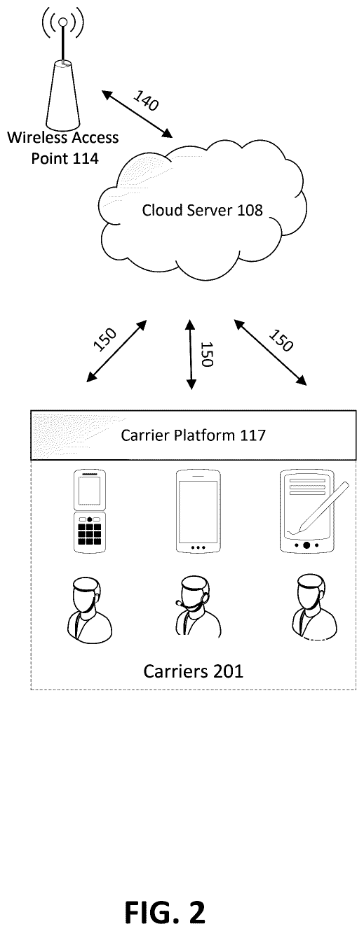

Also, the garage door opening controller 100 may also include a siren 111 for alerting the homeowner when conditions from sensors 118 are out of threshold readings. The sensors may be a humidity sensor, a temperature sensor, carbon monoxide (CO2) or a smoke detector. When the sensors 118 display high readings or emergency conditions. Siren 111 may be actuated. The command to actuate siren 111 is sent to through the wireless access point (WAP) 114. The WAP sends commands to and from the universal garage door controller 100 across bidirectional communication link 120 and bidirectional link 130. Also in communication with u universal garage door controller 100 is the carrier platform 117. The carrier platform 117 communicates with the universal garage door controller 100 across bidirectional link 150, through the cloud server 108, across bidirectional link 140 and finally to the wireless access point 114 and across link 120. The carrier platform 117 may send commands to actuate the garage door upon successful scan of a parcel. The garage door opening controller 100 may also include a speaker microphone 103 to allow for 2-way communication between the delivery associate and the homeowner. For example, if a homeowner isn't present at the location at the time of delivery, the homeowner may speak to the delivery associate the over the bi-directional communication link 102 and the speaker/microphone 103, too further confirm that delivery has occurred. Described later in greater detail with respect to FIG. 2.

Now referring to FIG. 2, as mentioned before upon successful scan of a parcel and the exchange of appropriate tokens, the carrier platform 117 may send commands across links 150, to cloud server 108 and finally to the WAP 114 and ultimately to the universal garage door controller 100, to enable the opening of a garage door. The information sent by the carrier platform can be the wireless access point IP address, including the physical location of the IP address. Multiple carriers can create tokens with this system. The tokens are created by the carriers and exchanged with the garage door opening controller 100 across the WAP 114.

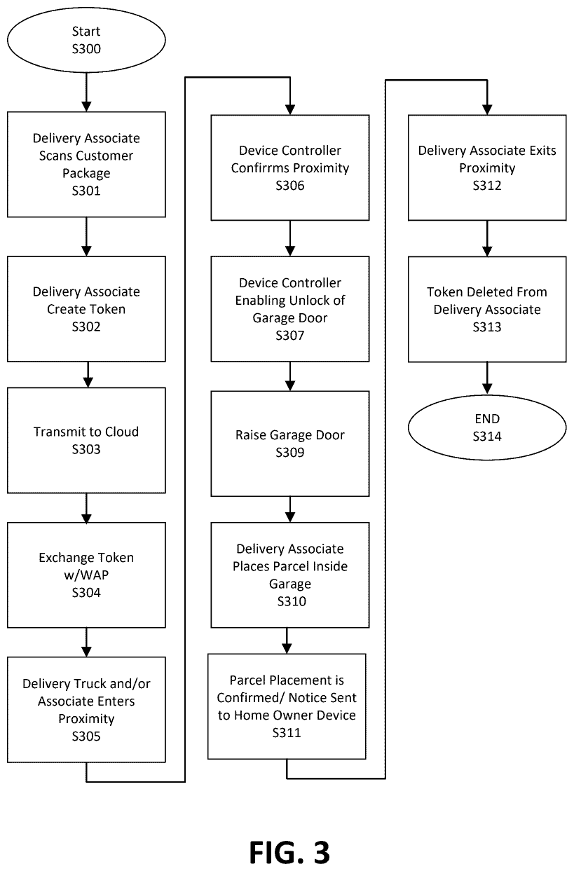

Referring now to FIG. 3, it depicts a flow chart showing how the garage door opening controller 100 can be used for enabling parcel deliveries according to the invention. The Process begins at step S300 and then proceeds to step S301. At S301, a delivery associate may scan a parcel. The delivery associate may be from any of the delivery companies such as FedEx, DHL, UPS, USPS, and the like. This process is not limited to which delivery company and is intended to be universal.

The process then continues to step S302, where a token is created. In the context of computing and digital technology, a “token” is a unit of data or a piece of information that serves as a representation of something else, often used for authentication, authorization, or identification purposes. Tokens are commonly employed in security systems to verify the identity of users or devices without transmitting sensitive information directly. For instance, in authentication processes, a token might be a digital key or a randomly generated string that grants access to a system or service. These tokens can be time-limited, ensuring that they expire after a certain period or after a specific action is completed, which enhances security by reducing the risk of unauthorized access.

After the token is created, the token is transmitted to cloud 108, at step 303 (as previously mentioned). The token provides temporary access to the open the garage.

The step continues to step S304, where the wireless access point's IP address is retrieved. This enables access of the delivery associate to temporarily open the garage. Once the delivery associate's truck has entered the proximity and it has been confirmed at Steps S305 and S306. Not until the delivery truck is in proximity and confirmed, does the process continue to step S308, where the garage door unlocking is enabled. Upon enabling the unlocking, the delivery associate can then access the actuate unlocking from a mobile app on his/her user device. The garage is raised at step S309.

The process then continues to step S310, where the delivery associate places the parcel in the garage. The process then continues to step S311 where parcel placement is confirmed by the HD camera and by artificial intelligence built into the HD camera, then confirmation is sent to the homeowner's user device that the parcel placement was successful. The process then continues to step S312, where the parcel has been placed, delivery confirmed, and the confirmation has been sent to the homeowner. The garage door is closed. Then the delivery associate exits the proximity, the token is then cancelled at step S313. The process then ends at step S314.

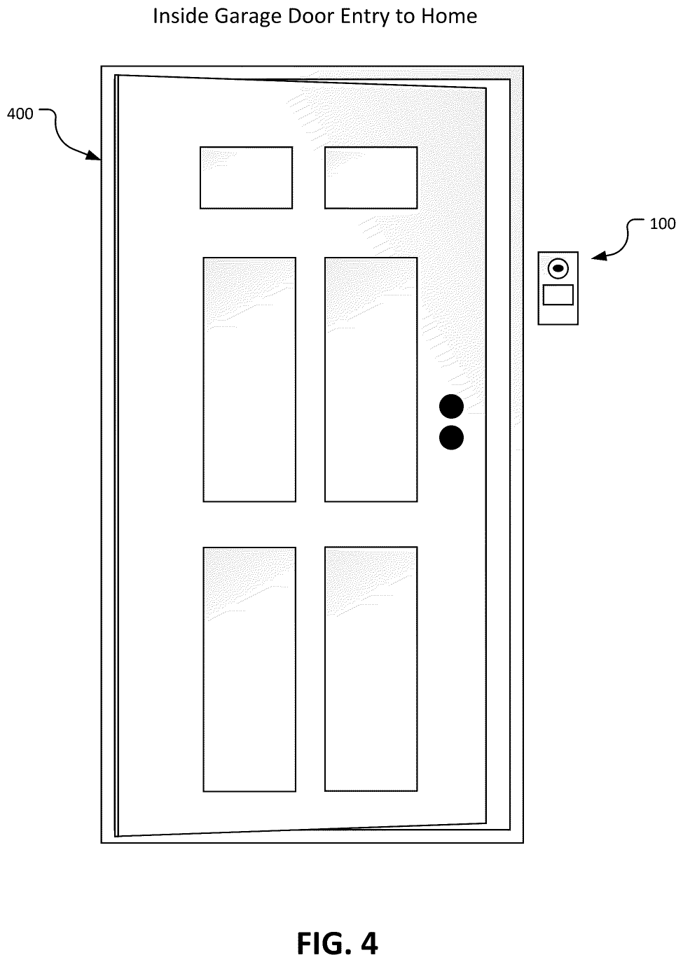

Referring now to FIG. 4, the figure represents the intended mounting position of the universal garage door controller 100. The universal garage door controller 100 is intended to be mounted just outside the interior door 400 that enters the interior of a home. It is intended to replace the dumb button that is traditionally installed with conventional systems. The universal garage door controller 100 should also be mounted so that the camera can view the location where parcels are delivered, according to the invention.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An underroof and in garage, garage door opening controller comprising:
a high definition (HD) camera for monitoring in-garage status of deliveries and other conditions;
a button for actuating a garage door, the garage door opening controller connectable to a wireless access point, wherein the wireless access point is connected to at least one sensor and a carrier platform.

2. The garage door opening controller of claim 1, the at least one sensor may be one of a carbon monoxide sensor, smoke detector, temperature sensor, and humidity sensor.

3. The garage door opening controller of claim 2, wherein based on a threshold reading from the at least one sensor, the at least one sensor may send a command to the controller to open the garage door a small distance so that the garage can be ventilated, to allow the threshold reading to be returned to acceptable levels and an alert is also sent to a mobile app monitoring a status of an interior of the garage.

4. The garage door opening controller of claim 3, wherein a siren can be actuated when the threshold reading has reached an emergency state.

5. The garage door opening controller of claim 4, wherein the threshold readings are continuously monitored for emergency conditions.

6. The garage door opening controller of claim 1, wherein the controller captures an image of an interior of the garage, via the camera, upon a delivery associate causing movement of the garage door as part of the delivery of an object in the garage by the delivery associate.

7. The garage door opening controller of claim 1, wherein the controller is connectable to a wireless controller (dongle) to enable commands from a carrier platform to enable the delivery associate to deliver packages to the garage.

8. The garage door opening controller of claim 3, wherein providing the alert includes:
causing a notification to be transmitted to a user device(s); and/or
providing an audible and/or visual alert at the garage door opening controller.

9. The garage door opening controller of claim 1, wherein delivery of an object into a garage with a garage door opening controller:
detecting, based on the image, a position of the object relative to a delivery location in the garage using artificial intelligence.

10. The garage door opening controller of claim 1 further comprising opening the garage door in response to a request, from a user controller of the delivery associate, to open the garage door.

11. A method for delivery of a parcel object comprising:
using an underroof and in garage, garage door opening controller comprising:
a high definition (HD) camera for monitoring in-garage status of deliveries and other conditions.
a wireless controller for actuating a garage door, the wireless controller connectable to a wireless access point, wherein the wireless access point is connected to a carrier platform.

12. The method of claim 11, wherein the controller captures an image of an interior of the garage, via the camera, upon a delivery associate causing movement of the garage door as part of the delivery of an object in the garage by the delivery associate.

13. The method of claim 12, wherein the garage door opening controller is connectable to the wireless controller to enable commands from a carrier platform to enable the delivery associate to deliver packages to the garage.

14. The method of claim 12, wherein delivery the of an object into a garage:
detecting, based on the image, a position of the object relative to a delivery location in the garage using artificial intelligence.

15. The method of claim 11, further comprising opening the garage door in response to a request, from a user controller of the delivery associate, to open the garage door.

16. A system for delivery of a parcel object comprising:
one or more processors configured to:
use an underroof and in garage, garage door opening controller comprising:
a high definition (HD) camera for monitoring in-garage status of deliveries and other conditions.
a wireless controller for actuating a garage door, the wireless controller connectable to a wireless access point, wherein the wireless access point is connected to a carrier platform.

17. The system of claim 16, wherein the controller captures an image of an interior of the garage, via the camera, upon a delivery associate causing movement of the garage door as part of the delivery of an object in the garage by the delivery associate.

18. The system of claim 17, wherein the garage door opening controller is connectable to the wireless controller (dongle) to enable commands from a carrier platform to enable the delivery associate to deliver packages to the garage.

19. The system of claim 17, wherein delivery the of an object into a garage:
detecting, based on the image, a position of the object relative to a delivery location in the garage using artificial intelligence.

20. The system of claim 16, further comprising: opening the garage door in response to a request, from a user controller of the delivery associate, to open the garage door.
